(19) United States
(12) Patent Application Publication
(10) Pub. No.: US 2007/0015453 A1
(43) Pub. Date: Jan. 18, 2007

(54) Extension kit for adjusting louvers

(76) Inventor: David Keith McAnally, Rector, AR (US)

Correspondence Address: Stephen D. Carver, Suite 800, 2024 Arkansas Valley Drive, Little Rock, AR, 72212-4147, US

(21) Appl. No.: 11/181,473

(22) Filed: Jul. 15, 2005

(51) Int. Cl. B60J 1/20

(52) U.S. Cl. 454/130

(57) ABSTRACT

A kit enabling roof-mounted ventilator louvers to be adjusted from the ground. A rotatable knob replaces the original knob sold with the louver fixture. The knob is secured by a suitable screw coaxially mounted at its center. An integral tube coaxially extending away from the knob engages the original linkage. A rigid D-ring is hinged to the knob, and hangs down from the knob center. An elongated activating stick rotates the knob to adjust the louver. The stick has an elongated handle that terminates in a hook that engages the D-ring. By suitably engaging the D-ring with the hook from the floor of the camper trailer, for example, the user can quickly and conveniently adjust the louvers. The D-ring is swivel-mounted so it can be deflected away to easily expose the mounting screw during installation, and so it can be rotated by the stick at an angle.

### BACKGROUND OF THE INVENTION

1. Field of the Invention

The present invention relates generally to vehicular ventilator louvers. More particularly, the present invention relates to a system for remotely adjusting ventilator louvers that are roof-mounted in recreational vehicles.

2. Description of the Related Art

Modern recreational vehicles commonly employ a variety of vents and louvers for ventilation. Camper trailers, for example, often have roof-mounted ventilators that have external, hinged covers that are deflected to open the louver. Common designs employ linkage extending to the cover that is activated by twisting a knob at the bottom of the fixture. The knobs must be grasped manually and turned to open or close the louvers.

However, recreational vehicle ventilator units that are roof-mounted are difficult to reach. Usually a stool or other elevating support must be employed so that the adjustment knobs can be reached. Even when standing on a portable stool, for example, louver adjustment can still be difficult. For example, particularly for the elderly, it can be uncomfortable to stand upright in an overextended position and try to twist knobs with ones arms fully extended. Furthermore, when standing on a stool or chair ones chances of falling and sustaining injury are increased.

An adjustment system that allows the user to open or close trailer ventilators while safely positioned on the floor below it is highly desirable.

### BRIEF SUMMARY OF THE INVENTION

This invention provides an extension tool kit for remotely adjusting roof-mounted louvers of the type commonly found in recreational vehicles.

The kit comprises a replacement knob that interconnects with the louver activating linkage system. The old knob is removed and discarded, and the replacement knob simply screws into place. A convenient mounting screw is positioned at the center of the knob for access. A rigid D-ring swiveled to the knob hangs down from the knob center. It can be deflected away to easily expose the mounting screw during installation.

An elongated activating stick is used to adjust the ventilator from the ground. The stick has an elongated handle that includes a resilient cover for ease of use. The stick terminates in a hook that engages the D-ring. By suitably engaging the D-ring with the hook from the floor of the camper trailer, for example, the user can quickly and conveniently adjust the louvers without standing on a stool or the like. Since the D-ring is swiveled, it can be driven by the stick even when the stick is angled relative to ground.

The handle is simply manipulated such that the hook engages the D-ring, and the handle is turned to rotate the knob. Once the ventilator has been opened or closed as desired, the stick is simply detached from the ventilator by withdrawing the hook. The stick can be stored in an out-of-the way position for later use.

Thus a basic object is to provide a system for adjusting vents and louvers.

Another object is to enable roof-mounted ventilating fixtures or louvers to be accessed from the ground.

A more specific object is to enable a person standing on the ground, or on the floor of a camper, to conveniently adjust a roof-mounted ventilator without the use of stools or the like.

A related object is to provide a replacement knob for ventilators hat enables the remote adjustment of louvers as aforesaid.

Another important object is to facilitate hand-operated adjustments to roof mounted louvers.

These and other objects and advantages of the present invention, along with features of novelty appurtenant thereto, will appear or become apparent in the course of the following descriptive sections.

### BRIEF DESCRIPTION OF THE SEVERAL VIEWS OF THE DRAWINGS

In the following drawings, which form a part of the specification and which are to be construed in conjunction therewith, and in which like reference numerals have been employed throughout wherever possible to indicate like parts in the various views:

FIG. 1 is a fragmentary, bottom isometric view of the adjustment system;

FIG. 2 is an enlarged, fragmentary, top isometric view thereof;

FIG. 3 is a fragmentary, side elevational view;

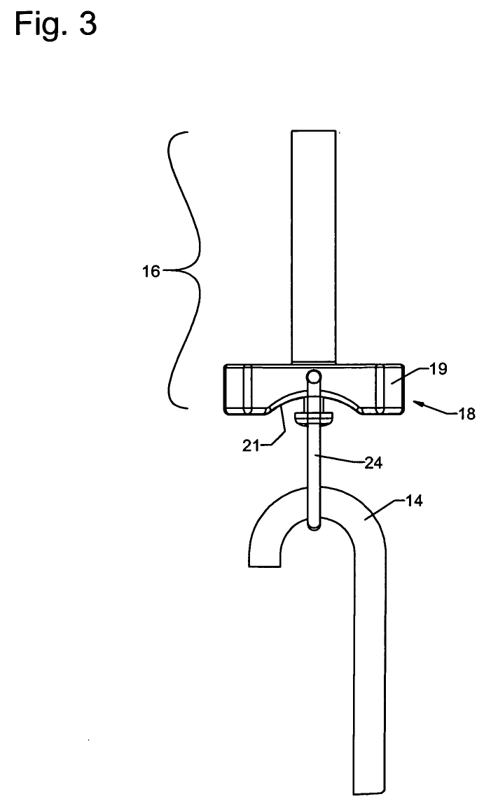

FIG. 4 is a fragmentary, front plan view;

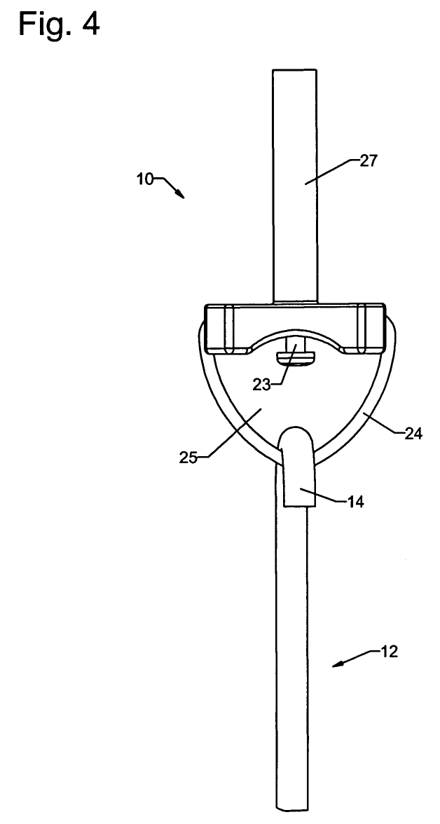

FIG. 5 is an enlarged top isometric view; and,

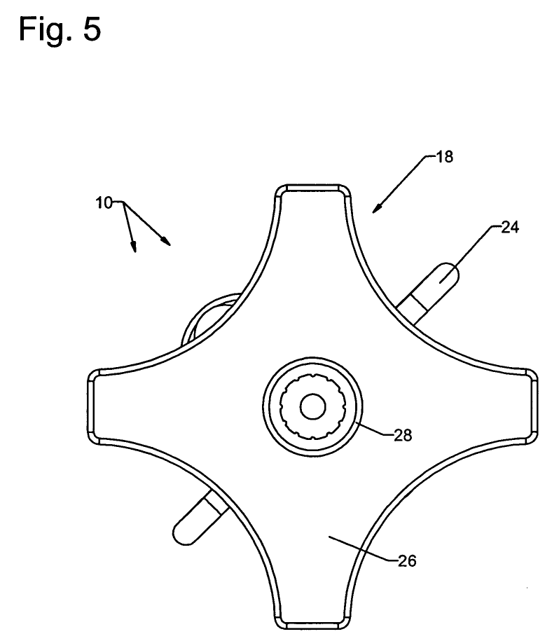

FIG. 6 is a fragmentary isometric view.

### DETAILED DESCRIPTION OF THE INVENTION

With reference now to the appended drawings, a louver adjustment kit has been generally designated by the reference numeral 10. Kit 10 is constructed in accordance with the best mode of the invention known to me at this time.

Kit 10 comprises an elongated activating stick 12 that is used to adjust the recreational vehicle ventilator louver. Stick 12 comprises an elongated handle portion 13 that is resiliently covered for ease of use. The stick terminates in a remote hook 14 that interacts with a knob assembly 16 that rotationally operates the louver linkage.

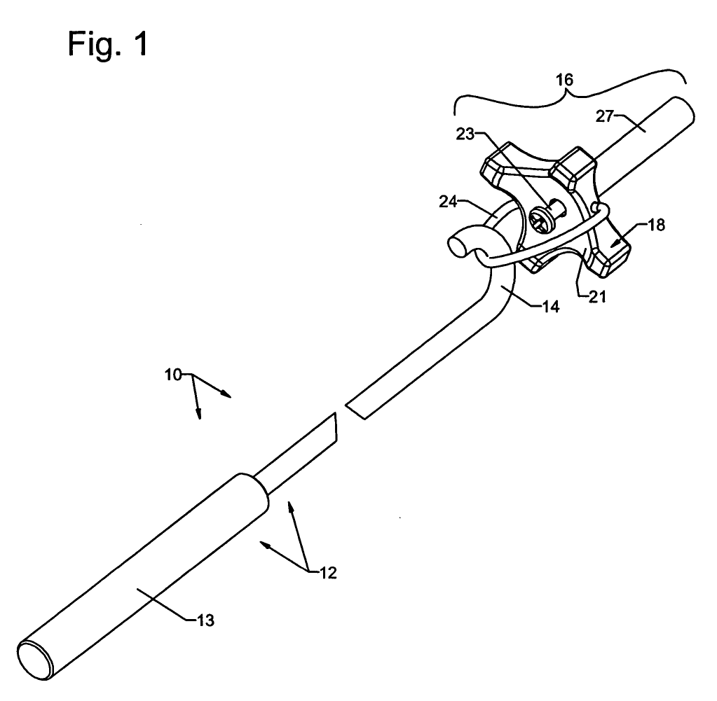

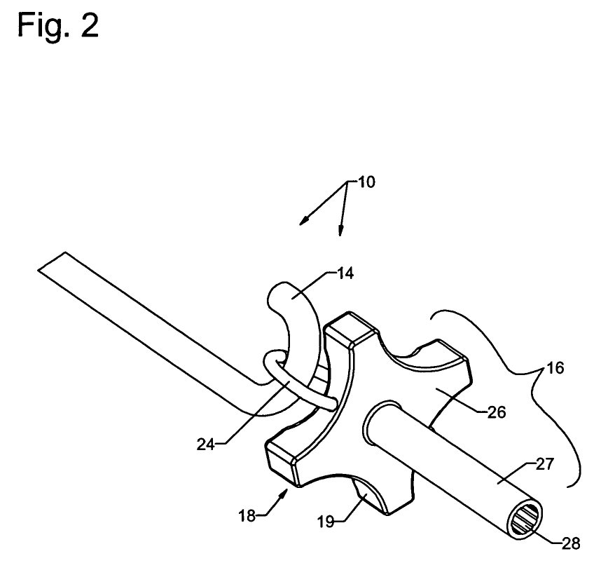

The knob assembly 16 comprises a replacement knob that interconnects with the original equipment louver. Specifically, the knob 18 replaces the original knob (not shown) that is included with the original fixture. Knob 18 has a plurality of radially spaced-apart facets 19 that ease handling. There is also a central depression 21 (FIG. 1), the center of which is penetrated by an elongated center fastener 23, which may be a Phillips screw or the like. A rigid, preferably metallic D-ring 24 is hinged to the knob, being connected at opposite knob sides. D-ring 24 is simply deflected away to allow access to fastener 23 during installation. The underside 26 of the knob 18, as viewed in FIG. 2, for example, faces the louver fixture after assembly. An elongated, tubular shank 27 extending coaxially away from the knob includes an open end 28 that receives and mates with a rotatable shaft (not shown) that is part of the original linkage system in the louver fixture.

Knob 18 and D-ring 24 are specially designed for several reasons. First, the swivel connection of D-ring 24 to knob 18 allows the ring 24 to fold back, exposing the center bottom region so center fastener 23 can be easily installed without obstruction.

A second major advantage achieved with the indicated structure is also obtained from the swivel mounting, which enables the D-ring 24 to fold up and out-of-the way when an operator wishes to operate the knob 24 manually by hand the same way the original knob operates. The latter feature allows persons that are tall enough to operate the knob without the extension stick with the ring 24 folded up to grip the knob properly.

A third important feature is that the D-ring 24 swivels to one side or the other to allow older persons to stand off to one side of the unit rather than being directly underneath it when operating the kit. Users need not stand directly under the unit, so they can see the D-ring and knob 24 better. Since the D-ring can be easily deflected manually into a more visible, and more-maneuverable position, it can be engaged by the stick at an angle. In other words, the stick can still engage and operate the D-ring by being first hooked and then rotated, even when it is disposed at an angle relative to the ground. This angular interconnection ability is made possible by swiveling of the ring which form a universal type joint.

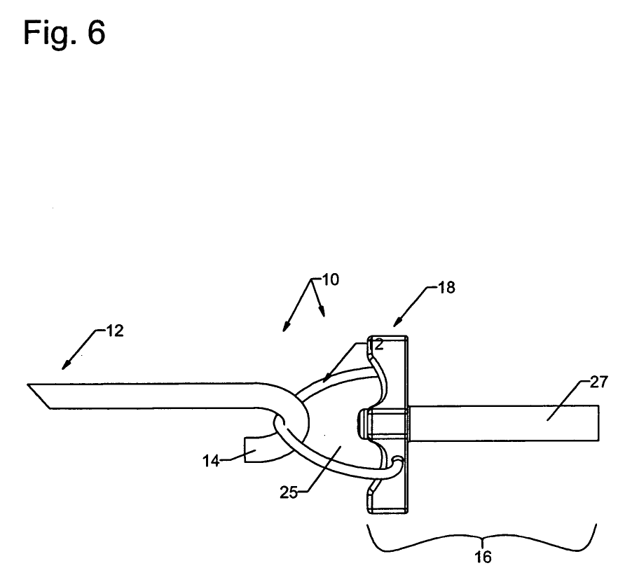

During installation, the old knob is removed and discarded, and the replacement knob 18 is simply screwed into place, with shank 27 engaging the fixture linkage. The mounting screw 23 is easily exposed by simply deflecting the D-ring 24 so that the center of the knob is unobstructed. Once the knob 18 is secured, the rigid D-ring 24 hinged to the knob hangs downwardly towards the floor of the camper or the ground. The knob can be twisted by the stick 12, simply by inserting the hook 14 through the D-ring orifice 25 (FIG. 6). When so connected, the hook 14 physically contacts and rotates the D-ring 24, forcing the knob 18 to rotate. Consequently, the louver is adjusted as desired.

Since the stick 12 provides an extension, the louvers can be easily accessed from the floor of a camper or RV. The stick handle is simply manipulated such that the hook engages the D-ring, and the handle is turned to rotate the knob assembly 16. Once the ventilator has been opened or closed as desired, the stick is simply detached from the ventilator by withdrawing the hook 14 from the D-ring 24. The stick can then be stored where desired for later use.

From the foregoing, it will be seen that this invention is one well adapted to obtain all the ends and objects herein set forth, together with other advantages which are inherent to the structure.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

What is claimed is:

1. A louver adjustment kit for rotationally operating a conventional roof-mounted louver ventilator, the kit comprising:
an elongated activating stick comprising a handle adapted to be manually grasped and manipulated, and a remote hook spaced apart from the handle;
a knob that interconnects with the louver;
means for securing the knob to the louver; and,
a D-ring coupled to the knob that is adapted to be engaged by the hook, whereby manual rotation of the stick rotates the knob to adjust the louver.

2. The kit as defined in claim 1 wherein the D-ring swivel mounts to the knob.

3. The kit as defined in claim 1 wherein the knob comprises an elongated tubular shank that comprises an open end for mating with an original linkage system in the louver ventilator

4. The kit as defined in claim 1 wherein the knob comprises a plurality of radially spaced-apart facets to ease handling.

5. The kit as defined in claim 4 wherein the knob comprises an elongated tubular shank that comprises an open end for mating with an original linkage system in the louver ventilator

6. The kit as defined in claim 5 wherein the D-ring swivel mounts to the knob.
